(19) United States
(12) Patent Application Publication
(10) Pub. No.: US 2023/0353040 A1
(43) Pub. Date: Nov. 2, 2023

(54) POWER CONVERSION CONTROL DEVICE, POWER CONVERSION SYSTEM, POWER CONVERSION CONTROL METHOD, AND RECORDING MEDIUM

(71) Applicant: Panasonic Intellectual Property Management Co., Ltd., Osaka (JP)

(72) Inventors: Hayato TAKAHASHI, Kanagawa (JP); Xinhao TIAN, Tokyo (JP); Yohei NAGATAKE, Kanagawa (JP)

(21) Appl. No.: 18/295,637

(22) Filed: Apr. 4, 2023

(30) Foreign Application Priority Data
Apr. 27, 2022 (JP) 2022-073314

(51) Int. Cl. H02M 1/32; H02M 1/00; H02M 1/36

(52) U.S. Cl. CPC H02M 1/32; H02M 1/0009; H02M 1/36

(57) ABSTRACT

A power conversion control device controls a power converter. The power converter converts AC power into DC power. The power conversion control device includes a hardware processor coupled to a memory. The processor performs overcurrent protection by which operation of the power converter is suspended. The overcurrent protection is performed when an amount of output current of the power converter is equal to or greater than a threshold value. The processor permits restart of operation of the power converter having been suspended by the overcurrent protection. The restart is permitted only when the overcurrent protection is performed due to decrease in output voltage of the power converter. The processor restarts operation of the power converter after the restart of operation of the power converter is permitted.

### CROSS-REFERENCE TO RELATED APPLICATIONS

This application is based upon and claims the benefit of priority from Japanese Patent Application No. 2022-073314, filed on Apr. 27, 2022, the entire contents of which are incorporated herein by reference.

### FIELD The present disclosure relates generally to a power conversion control device, a power conversion system, a power conversion control method, and a recording medium.

### BACKGROUND

A power converter has been known, which is used for, for example, charging a storage battery mounted on a vehicle and which converts AC power from an external power source into DC power (for example, JP 6852522 B).

The above-described power converter tries to keep the output current constant. However, for example, in a case where the output voltage steeply decreases and the feedback operation of the power converter cannot follow the change in output voltage, the output current increases due to decrease in output voltage because the output power is constant. As a result, when an amount of the output current exceeds the threshold value, the overcurrent protection is activated and thereby the power converter is suspended (charging of the storage battery by the power converter is also suspended).

In the related art, as a permission condition for restarting the operation of the power converter having been suspended due to the overcurrent protection, special processing (for example, processing of executing the charging operation again after a lapse of a given period of time and continuing the charging operation if overcurrent protection does not occur) or special operation (for example, operation of once removing the connector for connecting the external power source system and the power converter and reconnecting the connector, or the like) has been required. For this reason, there is a problem that the burden on the user increases, and it takes time to restart the operation of the power converter, so that the operation efficiency of the power converter also deteriorates.

### SUMMARY

A power conversion control device according to the present disclosure is a power conversion control device that controls a power converter. The power converter converts AC power into DC power. The power conversion control device includes a hardware processor coupled to a memory. The hardware processor is configured to perform overcurrent protection by which operation of the power converter is suspended. The overcurrent protection is performed when an amount of output current of the power converter is equal to or greater than a threshold value. The hardware processor is configured to permit restart of operation of the power converter having been suspended by the overcurrent protection. The restart is permitted only when the overcurrent protection is performed due to decrease in output voltage of the power converter. The hardware processor is configured to restart operation of the power converter after the restart of operation of the power converter is permitted.

### BRIEF DESCRIPTION OF THE DRAWINGS

FIG. 1 is a diagram illustrating an example of a configuration of a vehicle according to the embodiment;

FIG. 2 is a diagram illustrating an example of a configuration of a power conversion system according to the embodiment;

FIG. 3 is a diagram for explaining the operation of a power converter according to the embodiment;

FIG. 4 is a diagram for explaining the operation of the power converter according to the embodiment;

FIG. 5 is a diagram illustrating an example of a hardware configuration of a power conversion control device according to the embodiment;

FIG. 6 is a diagram illustrating an example of functions of the power conversion control device according to the embodiment;

FIG. 7 is a timing chart illustrating an operation example of the power conversion control device according to the embodiment; and

FIG. 8 is a flowchart illustrating an operation example of the power conversion control device according to the embodiment.

### DETAILED DESCRIPTION

Hereinafter, embodiments of a power conversion control device, a power conversion system, a power conversion control method, and a recording medium according to embodiments of the present disclosure will be described in detail with reference to the accompanying drawings.

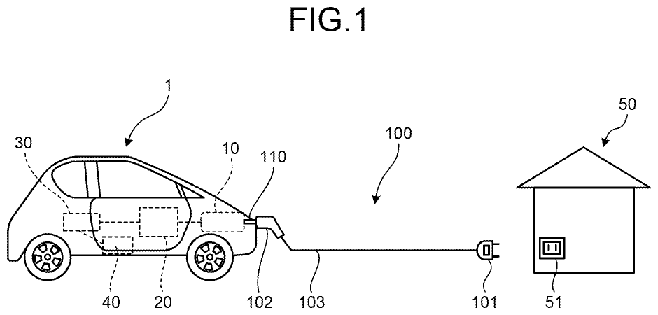

FIG. 1 is a diagram illustrating an example of a configuration of a vehicle 1 of the present embodiment. The vehicle 1 is an example of a moving body that moves by electric power as a power source. The vehicle 1 according to the present embodiment is an electric vehicle that travels by power of a traveling motor driven by electric power.

As illustrated in FIG. 1, the vehicle 1 includes at least a power conversion system 10, a battery 20, an inverter 30, and a traveling motor 40.

The power conversion system 10 converts, into DC power, AC power supplied from an external power supply source 50 via a cable 100 and a connector 110, and supplies the converted DC power to the battery 20. A detailed configuration of the power conversion system 10 will be described later.

The power supply source 50 is a single-phase 100 V or 200 V commercial power source installed in, for example, an ordinary home or a business place. Note that, for example, the power supply source 50 may be a public charging facility that is provided in an urban area such as a charging stand or under a road surface and that is premised on use by an unspecified number of users.

The cable 100 is used for connecting the power supply source 50 and the vehicle 1 when the battery 20 mounted on the vehicle 1 is charged. As illustrated in FIG. 1, the cable 100 includes a power source plug 101, a charging coupler 102, and a connection cable 103.

The power source plug 101 is detachably connected to a power source outlet (socket) 51 of the power supply source 50. The charging coupler 102 is detachably connected to a power converter 210 described later included in the power conversion system 10 via the connector 110. The connection cable 103 connects the power source plug 101 and the charging coupler 102.

The battery 20, which can be charged with the DC power converted by the power conversion system 10, may comprises a lithium ion battery, for example. The inverter 30 converts power output from the battery 20 into AC power and supplies the AC power to the traveling motor 40. The traveling motor 40 is driven by power supplied from the inverter 30 to rotate the wheels.

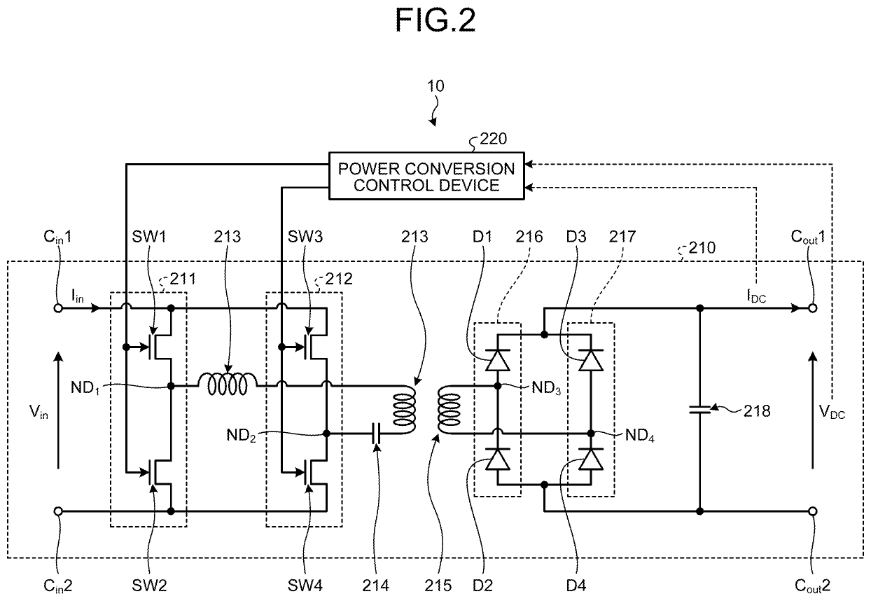

Next, a configuration of the power conversion system 10 will be described. FIG. 2 is a diagram illustrating an example of a configuration of the power conversion system 10 according to the present embodiment. As illustrated in FIG. 2, the power conversion system 10 includes a power converter 210 that converts AC power into DC power, and a power conversion control device 220 that controls the power converter 210.

As illustrated in FIG. 2, the power converter 210 includes a pair of input terminals Cin1 and Cin2, a first switching element group 211, a second switching element group 212, a primary coil 213, a capacitor element 214, a secondary coil 215, a first rectifier element group 216, a second rectifier element group 217, a capacitor element 218, and a pair of output terminals Cout1 and Cout2 connectable to the battery 20.

The pair of input terminals Cin1 and Cin2 is connected to a rectifier circuit (not illustrated) that rectifies AC power supplied from the connector 110. DC power corresponding to AC power from the connector 110 is input to the pair of input terminals Cin1 and Cin2.

The first switching element group 211 includes a first switching element SW1 and a second switching element SW2 which are connected in series with each other. The ON/OFF operation of each of the first switching element SW1 and the second switching element SW2 is exclusively controlled by the power conversion control device 220.

Specifically, the power conversion control device 220 controls the second switching element SW2 to be in the OFF state when the first switching element SW1 is in the ON state, and controls the second switching element SW2 to be in the ON state when the first switching element SW1 is in the OFF state. Each of the first switching element SW1 and the second switching element SW2 may be configured by, for example, a transistor such as a metal-oxide-semiconductor field-effect transistor (MOSFET) that is switched on and off in accordance with a voltage applied to a gate.

The first switching element group 211 is connected in parallel to the input terminals Cin1 and Cin2. More specifically, out of the terminals of the first switching element SW1, a terminal not connected to the second switching element SW2 is connected to the input terminal Cin1. Out of the terminals of the second switching element SW2, a terminal not connected to the first switching element SW1 is connected to the input terminal Cin2.

The second switching element group 212 includes a third switching element SW3 and a fourth switching element SW4 which are connected in series with each other. The ON/OFF operation of each of the third switching element SW3 and the fourth switching element SW4 is exclusively controlled by the power conversion control device 220. Specifically, the power conversion control device 220 controls the fourth switching element SW4 to be in the OFF state when the third switching element SW3 is in the ON state, and controls the fourth switching element SW4 to be in the ON state when the third switching element SW3 is in the OFF state. Each of the third switching element SW3 and the fourth switching element SW4 may be configured by, for example, a transistor such as a MOSFET that is switched on and off according to a voltage applied to a gate.

The second switching element group 212 is disposed at a stage (output side) subsequent to the first switching element group 211, and is connected in parallel to the input terminals Cin1 and Cin2. More specifically, out of the terminals of the third switching element SW3, a terminal not connected to the fourth switching element SW4 is connected to one input terminal Cin1. Out of the terminals of the fourth switching element SW4, a terminal not connected to the third switching element SW3 is connected to the other input terminal Cin2.

As illustrated in FIG. 2, the primary coil 213 and the capacitor element 214 are connected in series between a connection point ND1 and a connection point ND2. The connection point ND1 is provided between the first switching element SW1 and the second switching element SW2. The connection point ND2 is provided between the third switching element SW3 and the fourth switching element SW4.

In the present embodiment, the power conversion control device 220 performs control such that the ON/OFF operation of the first switching element SW1 and the fourth switching element SW4 synchronize with each other, and performs control such that the ON/OFF operation of the second switching element SW2 and the third switching element SW3 synchronize with each other. The power conversion control device 220 switches the direction of the current flowing through the primary coil 213 by alternately switching between: the ON state of the first switching element SW1 and the fourth switching element SW4 (while the second switching element SW2 and the third switching element SW3 are in the OFF state); and the ON state of the second switching element SW2 and the third switching element SW3 (while the first switching element SW1 and the fourth switching element SW4 are in the OFF state).

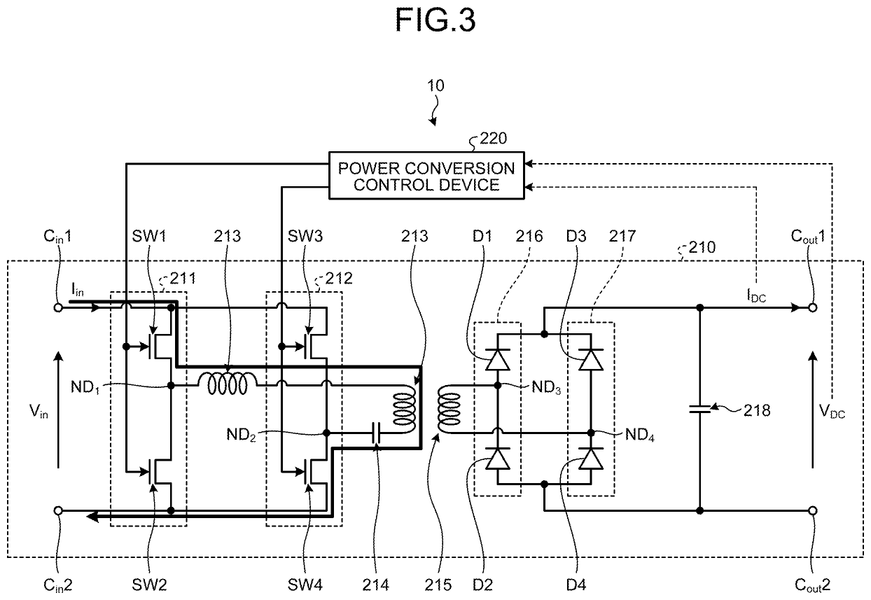

It is assumed that, for example, the first switching element SW1 and the fourth switching element SW4 are turned on while the second switching element SW2 and the third switching element SW3 are turned off, under the control of the power conversion control device 220. In this case, as illustrated in FIG. 3 with a thick line, a current flows in a direction from the input terminal Cin1 toward the input terminal Cin2 via the first switching element SW1 being in the ON state, the primary coil 213, and the fourth switching element SW4 being in the ON state.

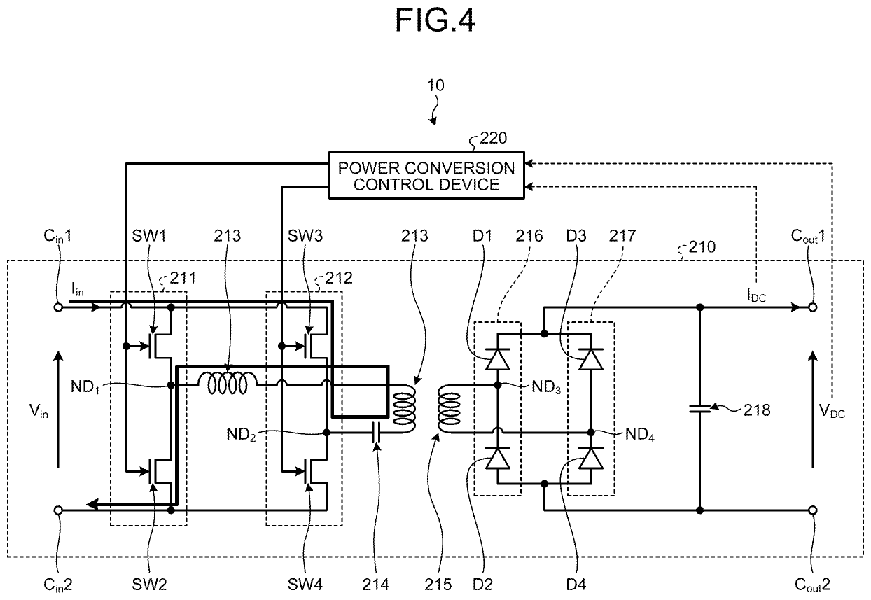

On the other hand, it is assumed that the first switching element SW1 and the fourth switching element SW4 are turned off while the second switching element SW2 and the third switching element SW3 are turned on, under the control of the power conversion control device 220. In this case, as illustrated in FIG. 4 with a thick line, a current flows in a direction from the input terminal Cin1 toward the input terminal Cin2 via the third switching element SW3 being in the ON state, the primary coil 213, and the second switching element SW2 being in the ON state.

As described above, an AC current flows in the primary coil 213, and an AC current is also generated in the secondary coil 215 by electromagnetic induction.

The description of FIG. 2 will be continued. As illustrated in FIG. 2, the first rectifier element group 216 disposed at a stage (output side) subsequent to the primary coil 213 includes a first rectifier element D1 and a second rectifier element D2 which are connected to each other in series. The first rectifier element group 216 is connected in parallel to the output terminals Cout1 and Cout2. More specifically, out of the terminals of the first rectifier element D1, a terminal not connected to the second rectifier element D2 is connected to one output terminal Cout1. Out of the terminals of the second rectifier element D2, a terminal not connected to the first rectifier element D1 is connected to the other output terminal Cout2. In this example, each of the first rectifier element D1 and the second rectifier element D2 rectifies a current in a direction from the bottom to the top in FIG. 2, and may be configured by, for example, a diode.

As illustrated in FIG. 2, the second rectifier element group 217 includes a third rectifier element D3 and a fourth rectifier element D4 which are connected to each other in series. The second rectifier element group 217 is disposed at a stage (output side) subsequent to the first rectifier element group 216, and is connected in parallel to the output terminals Cout1 and Cout2. More specifically, out of the terminals of the third rectifier element D3, a terminal not connected to the fourth rectifier element D4 is connected to one output terminal Cout1. Out of the terminals of the fourth rectifier element D4, a terminal not connected to the third rectifier element D3 is connected to the other output terminal Cout2. In this example, each of the third rectifier element D3 and the fourth rectifier element D4 rectifies a current in a direction from the bottom to the top in FIG. 2, and may be configured by, for example, a diode.

As illustrated in FIG. 2, the secondary coil 215 is connected between a connection point ND3 and a connection point ND4. The connection point ND3 is provided between the first rectifier element D1 and the second rectifier element D2. The connection point ND4 is provided between the third rectifier element D3 and the fourth rectifier element D4. With this configuration, the current (output current I_{DC}) output from the first rectifier element group 216 or the second rectifier element group 217 can be rectified in a given direction regardless of a flowing direction of a current generated at the secondary coil 215.

In a case where, for example, the current generated in the secondary coil 215 flows in the direction from the bottom to the top in FIG. 2, the direction of the output current IDC is the direction defined by the first rectifier element D1 (the direction from the bottom to the top in FIG. 2). On the other hand, when the current generated in the secondary coil 215 flows in the direction from the top to the bottom in FIG. 2, the direction of the output current IDC is the direction defined by the third rectifier element D3 (the direction from the bottom to the top in FIG. 2). In this manner, whichever of the bottom to the top and the top to the bottom the current in the secondary coil 215 flows, the output current IDC is rectified by the first rectifier element group 216 or the second rectifier element group 217 so as to flow from the bottom to the top in FIG. 2.

In addition, as illustrated in FIG. 2, the capacitor element 218 is disposed at a stage subsequent to the first rectifier element group 216 and the second rectifier element group 217, and is connected in parallel to the output terminals Cout1 and Cout2. One electrode of the pair of electrodes of the capacitor element 218 is connected to the output terminal Cout1, and the other electrode is connected to the output terminal Cout2. The capacitor element 218 serves to smooth the output current I_{DC} rectified by the first rectifier element group 216 and the second rectifier element group 217.

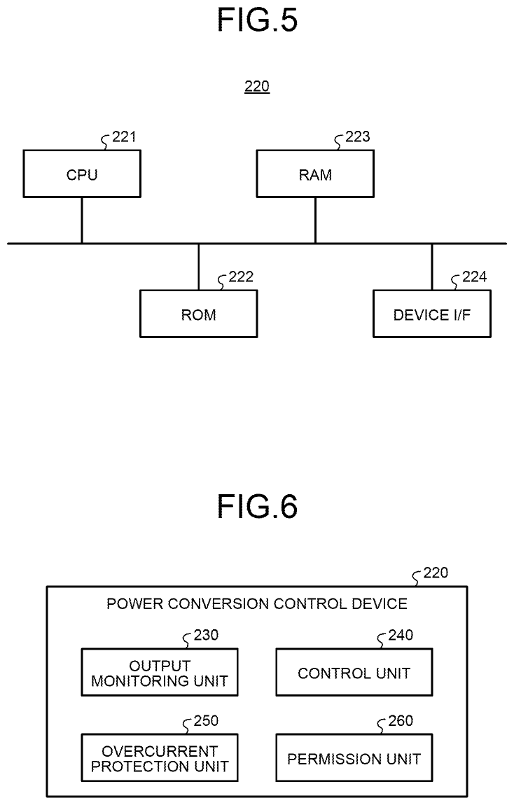

Next, a configuration of the power conversion control device 220 will be described. FIG. 5 is a diagram illustrating an example of a hardware configuration of the power conversion control device 220. As illustrated in FIG. 5, the power conversion control device 220 includes a central processing unit (CPU) 221, a read only memory (ROM) 222, a random access memory (RAM) 223, and a device I/F 224.

The CPU 221 (an example of the hardware processor) executes a computer program to integrally control the operation of the power conversion control device 220 and implement various functions of the power conversion control device 220. The ROM 222 is a nonvolatile memory, and stores various pieces of data including computer programs corresponding to various functions of the power conversion control device 220. The RAM 223 is a volatile memory having a work area of the CPU 221. The device I/F 224 is an interface for connection with an external device such as the power converter 210.

FIG. 6 is a diagram illustrating an example of functions of the power conversion control device 220. As illustrated in FIG. 6, the power conversion control device 220 includes an output monitoring unit 230, a control unit 240, an overcurrent protection unit 250, and a permission unit 260. Although the example of FIG. 6 illustrates an example of the functions of the power conversion control device 220, the power conversion control device 220 may further have other functions.

The output monitoring unit 230 monitors (or detects) the output of the power converter 210. More specifically, the output monitoring unit 230 monitors the output current I_{DC} of the power converter 210 and the output voltage V_{DC} between the output terminals Cout1 and Cout2.

The control unit 240 controls the operation of the power converter 210 on the basis of the output monitored by the output monitoring unit 230. In the present example, the input current Iᵢₙ input to the input terminal Cin and the input voltage Vᵢₙbetween the input terminals Cin1 and Cin2 are constant, and the control unit 240 controls the ON/OFF operations of the first switching element SW1 to the fourth switching element SW4 of the power converter 210 so as to keep the output current I_{DC} constant. The time during which each of the first to fourth switching elements SW1 to SW4 is in the ON state (ON time) is fixed. Therefore, the control unit 240 is able to change the switching frequency by variably switching the intervals at which the ON state of the first switching element SW1 and the fourth switching element SW4 and the ON state of the second switching element SW2 and the third switching element SW3 are switched.

The overcurrent protection unit 250 performs overcurrent protection by which the operation of the power converter 210 is suspended. The overcurrent protection is performed when an amount of the output current I_{DC} of the power converter 210 is equal to or greater than a threshold value. More specifically, when an amount of the output current I_{DC} of the power converter 210 is equal to or greater than the threshold value, the overcurrent protection unit 250 keeps all the first to fourth switching elements SW1 to SW4 of the power converter 210 in the OFF state (namely, suspends the switching operation).

In this example, when the amount of the output current I_{DC} of the power converter 210 is equal to or greater than the threshold value, an OCP flag, which indicates that the condition of overcurrent protection is satisfied, is enabled (high level in this example). In addition, in a case where the overcurrent protection has been performed, an error flag, which indicates a state where the power converter 210 is inoperable, is enabled (high level in this example). Then, when the permission unit 260 described later permits the restart of the operation of the power converter 210, the error flag is disenabled (low level in this example). The enabling/disenabling of the OCP flag and the error flag may be switched by the overcurrent protection unit 250 or the permission unit 260 described later, or may be switched by another function.

The permission unit 260 permits the restart of the operation of the power converter 210 having been suspended by the overcurrent protection, only when the overcurrent protection is performed due to decrease in the output voltage V_{DC} of the power converter 210. More specifically, the permission unit 260 permits the restart of the operation of the power converter 210 only when the overcurrent protection is performed due to a condition where the output voltage V_{DC} of the power converter 210 becomes equal to or less than the predetermined value. Note that, for example, the permission unit 260 may permit the restart of the operation of the power converter 210 only when the overcurrent protection is performed due to a condition where the amount of decrease in the output voltage V_{DC} of the power converter 210 per unit time is equal to or greater than a predetermined amount.

Moreover, for example, the permission unit 260 may permit the restart of the operation of the power converter 210 only when the overcurrent protection is performed due to a condition where the output voltage V_{DC} of the power converter 210 is equal to or less than a predetermined value and the amount of decrease in the output voltage V_{DC} per unit time is equal to or greater than a predetermined amount.

The control unit 240 restarts the operation of the power converter 210 after the permission unit 260 permits the restart of the operation of the power converter 210.

The functions of the output monitoring unit 230, the control unit 240, the overcurrent protection unit 250, and the permission unit 260 included in the power conversion control device 220 described above are implemented by, for example, the CPU 221 executing computer programs stored in the ROM 222. However, the present invention is not limited thereto. For example, some of or all the functions of the above-described units may be implemented by dedicated hardware circuitry. In addition, the functions of the above-described units may be installed in multiple devices in a distributed manner.

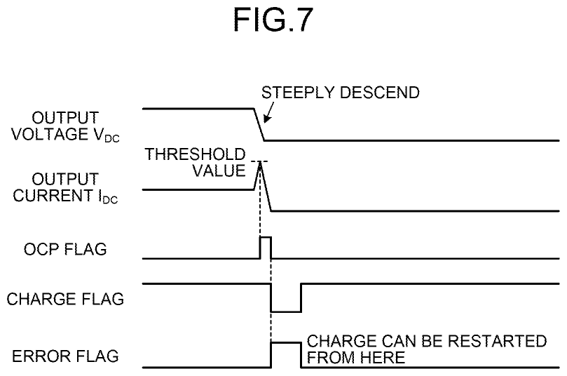

FIG. 7 is a timing chart illustrating an operation example of the power conversion control device 220 when overcurrent protection occurs. As illustrated in FIG. 7, when the output voltage V_{DC} decreases steeply and becomes equal to or less than a predetermined value, and the feedback operation (switching operation for keeping the output current I_{DC} constant) of the power converter 210 cannot follow the change in the output voltage V_{DC}, the output current I_{DC} increases.

When the amount of the output current I_{DC} is equal to or greater than the threshold value, the condition of the overcurrent protection is satisfied, and the OCP flag transitions to the high level. Then, the overcurrent protection unit 250 performs the overcurrent protection, and the operation of the power converter 210 is suspended (charging of the battery 20 is suspended). When the operation of the power converter 210 is suspended, the OCP flag transitions to a low level. Additionally, a charge flag indicating whether charging is possible transitions from a high level to a low level. The high level indicates that charging is possible, and the low level indicates that charging is impossible. In addition, the above-described error flag transitions to a high level.

Upon recognizing that the overcurrent protection is performed due to a condition where the output voltage V_{DC} is equal to or less than the predetermined value, the permission unit 260 permits the restart of the operation of the power converter 210. In response to the permission by the permission unit 260, the error flag transitions to a low level, the charge flag transitions to a high level, and thereby the control unit 240 can restart the operation of the power converter 210.

In the example of FIG. 7, the overcurrent protection is performed due to the condition where the output voltage V_{DC} is equal to or less than the threshold value. This is determined that overcurrent is caused by a steep decrease in the output voltage V_{DC}. Therefore, the error flag can be released without requiring a special recovery operation or the like.

As a condition for releasing the error flag (a condition for permitting the restart of the operation of the power converter 210), for example, a configuration (comparison example) is also considered such that the connector 110 is detached from the power converter 210 and is connected again. In this comparison example, even if an overcurrent due to a steep decrease in the output voltage V_{DC} for which the above-described special restoration operation is not required (connection of the connector 110 or the like does not matter), a user is required to perform operation of detaching the connector from the power converter 210 and reconnecting the connector 110 in order to release the error flag. For this reason, since the load on the user is large and it takes time to restart the operation of the power converter 210, the operation efficiency of the power converter 210 also deteriorates.

In contrast, according to the example of the present embodiment illustrated in FIG. 7, when the overcurrent protection is performed due to the condition where the output voltage V_{DC} is equal to or less than the predetermined value, the error flag is released without requiring a special operation such as reconnection of the connector 110. Therefore, it is possible to shorten the time to restart the operation of the power converter 210 as compared with the comparison example described above. As a result, the operation efficiency of the power converter 210 can be improved while reducing the burden on the user.

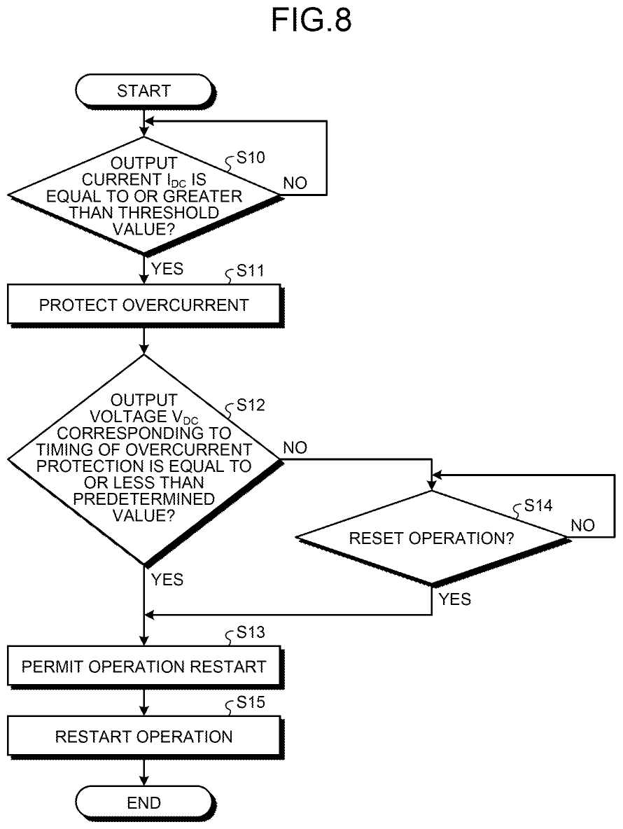

FIG. 8 is a flowchart illustrating an operation example of the power conversion control device 220 when overcurrent protection occurs. As illustrated in FIG. 8, when an amount of the output current IDC of the power converter 210 is equal to or greater than the threshold value (step S10: Yes), the overcurrent protection unit 250 performs the overcurrent protection (step S11).

Next, the permission unit 260 checks whether the output voltage V_{DC} (the output voltage V_{DC} at the most recent timing such as immediately before the overcurrent protection is performed) corresponding to the timing of the overcurrent protection is equal to or less than a predetermined value (step S12). When the determination result of step S12 is affirmative (step S12: Yes), the permission unit 260 permits the restart of the operation of the power converter 210 (step S13). On the other hand, when the determination result of step S12 is negative (step S12: No), the permission unit 260 permits the restart of the operation of the power converter 210 only when receiving a special operation (reset operation) for releasing the error flag that has been enabled due to a cause other than the steep decrease in the output voltage V_{DC} (step S14: Yes) (step S13).

After step S13, the error flag is released, and the control unit 240 restarts the operation of the power converter 210 (step S15).

As described above, the power conversion control device 220 of the present embodiment is configured to permit the restart of the operation of the power converter 210 having been suspended by the overcurrent protection, only when the overcurrent protection is performed due to decrease in the output voltage V_{DC} of the power converter 210. As a result, the power conversion control device 220 identifies the cause of occurrence of the overcurrent, and the error flag is released without requiring a special operation such as reconnection of the connector 110. Therefore, the time until the operation of the power converter 210 is restarted can be shortened. According to the present embodiment, the operation efficiency of the power converter 210 can be improved while reducing the burden on the user.

While certain embodiments have been described, these embodiments have been presented by way of example only, and are not intended to limit the scope of the inventions. Indeed, the novel methods and systems described herein may be embodied in a variety of other forms; moreover, various omissions, substitutions and changes in the form of the methods and systems described herein may be made without departing from the spirit of the inventions. The accompanying claims and their equivalents are intended to cover such forms or modifications as would fall within the scope and spirit of the inventions.

In addition, in the embodiment of the present disclosure, an example that the power conversion system 10 is applied to the vehicle 1 is described, but the present invention is not limited thereto. The power conversion system 10 can be applied to various devices. Moreover, the effects of the embodiments described in the present specification are merely examples and are not limited, and other effects may be provided.

According to the present disclosure, it is possible to improve the operation efficiency of the power converter while reducing the burden on the user.

What is claimed is:

1. A power conversion control device controlling a power converter, the power converter converting AC power into DC power, the power conversion control device comprising:
a hardware processor coupled to a memory and configured to:
perform overcurrent protection by which operation of the power converter is suspended, the overcurrent protection being performed when an amount of output current of the power converter is equal to or greater than a threshold value;
permit restart of operation of the power converter having been suspended by the overcurrent protection, the restart being permitted only when the overcurrent protection is performed due to decrease in output voltage of the power converter; and
restart operation of the power converter after the restart of operation of the power converter is permitted.

2. The power conversion control device according to claim 1, wherein the hardware processor is configured to permit the restart of operation of the power converter only when the overcurrent protection is performed due to a condition where an output voltage of the power converter becomes equal to or less than a predetermined value.

3. The power conversion control device according to claim 1, wherein the hardware processor is configured to permit the restart of operation of the power converter only when the overcurrent protection is performed due to a condition where an amount of decrease in output voltage of the power converter per unit time becomes equal to or greater than a predetermined amount.

4. The power conversion control device according to claim 2, wherein the hardware processor is configured to permit the restart of operation of the power converter only when the overcurrent protection is performed due to a condition where an amount of decrease in output voltage of the power converter per unit time becomes equal to or greater than a predetermined amount.

5. The power conversion control device according to claim 1, wherein
an error flag is enabled when the overcurrent protection is performed, the error flag indicating a state where the power converter is inoperable, and
the error flag is disabled when the restart of operation of the power converter is permitted.

6. A power conversion system comprising:
a power converter configured to convert AC power into DC power; and
a power conversion control device configured to control the power converter, the power conversion control device including a hardware processor coupled to a memory and configured to:
perform overcurrent protection by which operation of the power converter is suspended, the overcurrent protection being performed when an amount of output current of the power converter is equal to or greater than a threshold value;
permit restart of operation of the power converter having been suspended by the overcurrent protection, the restart being permitted only when the overcurrent protection is performed due to decrease in output voltage of the power converter; and
restart operation of the power converter after the restart of operation of the power converter is permitted by the permission unit.

7. A power conversion control method implemented by a power conversion control device controlling a power converter, the power converter converting AC power into DC power, the method comprising:
performing overcurrent protection by which operation of the power converter is suspended, the overcurrent protection being performed when an amount of output current of the power converter is equal to or greater than a threshold value;
permitting restart of operation of the power converter having been suspended by the overcurrent protection, the restart being permitted only when the overcurrent protection is performed due to decrease in output voltage of the power converter; and
restarting operation of the power converter after the restart of operation of the power converter is permitted.

8. A non-transitory computer-readable recording medium on which programmed instructions are recorded, the instructions causing a computer to execute processing, the processing comprising:
performing overcurrent protection by which operation of the power converter is suspended, the overcurrent protection being performed when an amount of output current of the power converter is equal to or greater than a threshold value;
permitting restart of operation of the power converter having been suspended by the overcurrent protection, the restart being permitted only when the overcurrent protection is performed due to decrease in output voltage of the power converter; and
restarting operation of the power converter after the restart of operation of the power converter is permitted.
